(19) United States
(12) Patent Application Publication
(10) Pub. No.: US 2012/0164445 A1
(43) Pub. Date: Jun. 28, 2012

(54) Fire Extinguishing Core

(75) Inventors: James T. Boyle, North Andover, MA (US); Kevin Paquin, Rowley, MA (US); Katherine Pelle, Peabody, MA (US)

(73) Assignee: BOSTIK, INC., Wauwatosa, WI (US)

(21) Appl. No.: 13/217,525

(22) Filed: Aug. 25, 2011

Related U.S. Application Data
(60) Provisional application No. 61/376,918, filed on Aug. 25, 2010.

(51) Int. Cl. B32B 7/12; C08K 13/02; C08L 75/04

(52) U.S. Cl. 428/352; 524/590; 524/94

(57) ABSTRACT

A fire extinguishing adhesive film includes outer layers of adhesive and an inner fire extinguishing core comprising a layer of resin containing a high concentration of fire retardant. Low levels of fire retardant may be blended into the adhesive layers, although it is preferred that the adhesive be pure. Polyurethane resin allows for a fire retardant loading of 86% by weight in the fire extinguishing core, and therefore provides significantly higher yields of fire retardant per unit area of the film without compromising adhesive performance.

### FIELD OF THE INVENTION

The invention relates to fire extinguishing films and in particular to films having a fire extinguishing core containing a high concentration of fire retardant pigments. The invention enables fire extinguishing adhesive films to exhibit superior adhesive performance and fire retardant properties.

### BACKGROUND OF THE INVENTION

Adhesive films loaded with fire retardant are known in the art. The commercial product is normally sold in roll form, and designed to be adhered to another product such as a decorative wall covering to render the decorative wall coating and the wall fire retardant. The roll contains a layer of adhesive with fire retardant dispersed homogeneously throughout the layer and coated onto a release liner. The layer of adhesive is transferred to another product for its end use, e.g. the back side of a decorative wall covering, by contacting the adhesive film with, and by adhering the adhesive film to, the end product and removing the release liner. Some fire retardant adhesive films use pressure sensitive adhesive, and some use heat activated adhesive, although other types of adhesive are also used with fire retardants.

In these prior art systems, fire retardant pigment is added to the adhesive resin and blended in order to distribute the fire retardant material evenly throughout the adhesive. Chemical fire retardants reduce flammability of materials by initiating a chemical reaction that slows the spread of the fire, or lowers the temperature of the fire, or stops the fire altogether. There are many different types of chemical fire retardants. One of the most common types used with polymers are brominated fire retardants. Two other common fire retardants are aluminum trihydrate and antimony pentoxide.

The use of fire retardant in adhesive, however, reduces adhesion performance. As a general matter, adhesion properties diminish somewhat proportionately as the fire retardant pigment is added to the adhesive. For this reason, existing fire retardant adhesive films typically use no more than 16% fire retardant pigment by weight, and some commercially available fire retardant adhesive films include much less fire retardant to improve adhesion performance.

In the aerospace industry, the construction of the fuselage interior must meet federal aviation regulations requiring the use of effective fire retardants to meet mandated flammability standards. The Ohio State University has developed a standardized test to determine rate of heat release and total heat release which are used by the FAA. A rate of heat release under 60 kW/m² meets the FAA standard inasmuch as maintaining the heat release level below 60 kW/m² has been determined to not propagate fire. The FAA specification for total heat release at 120 seconds is below 100 kW*minutes/m². Fire retardant adhesive films are adhered to the back side of decorative polyvinyl fluoride wall coatings and to the composite walls forming the interior of passenger cabin in an airplane so that the combination of materials meets the FAA standards.

An object of the present invention is to provide a fire extinguishing adhesive film which when used with a decorative polyvinyl fluoride wall coating will exceed the FAA standards, and also allow for the use of less material and weight. As mentioned, with existing fire retardant adhesive film, the fire retardant comprises up to about 16% of the total weight. A fire retardant adhesive film with a 50 micron thickness weighs about 67.7 g/m², and therefore yields about 10.85 g/m² of fire retardant. It is desirable to reduce the film weight if possible in order to reduce the weight of the aircraft and save fuel costs.

### SUMMARY OF THE INVENTION

In one aspect, the invention pertains to a fire extinguishing core in a laminated adhesive film. The fire extinguishing core preferably comprises a layer of binding resin loaded with a high concentration of fire retardant material. The fire extinguishing core resides between two functional layers of adhesive, for example between two layers of pressure sensitive adhesive. The layers of adhesive do not need to include fire retardant additives, and therefore the adhesion properties of these layers are not compromised. In use, the fire extinguishing adhesive film is applied to materials such as decorative wall coatings to render the decorative wall coating fire retardant. The invention enables the use of a higher level of fire retardant compared to prior art systems that blend the fire retardant throughout the adhesive. Concentrating all or most of the fire retardant pigment in the film core allows for a higher pigment to binder ratio. Also, removing all or part of the fire retardant from the outer coating improves the performance of the outer coating proportionally.

The fire extinguishing core comprises a binding resin that is capable of holding a high concentration of fire retardant pigments without physical compromise. Resins contemplated for implementing the invention include polyurethane, polyester, polyacrylate, polyethylene, polypropylene, polyvinylchloride, polyvinylflouride, polyamide, etc. Any resin capable of being solvated or extruded is a candidate resin as long as it is able to maintain its physical integrity when loaded with a high concentration of fire retardant pigment and is also able to adhere to the functional layers, e.g. adhesive layers.

While the invention contemplates the use of various types of fire retardants, in the exemplary embodiment the fire retardant pigments include a mixture of ethylenebistetrabromophthalimide, aluminum trihydrate and antimonypentoxide. In the exemplary embodiment, the fire retardant pigment is physically mixed in a polyurethane solution, preferably also including solvents, a cross linking agent, a surfactant.

In one embodiment, the invention is embodied in a process of making a laminated, fire extinguishing, pressure sensitive adhesive film. A first solvent-based adhesive layer is applied to a silicone coated release liner in liquid form using, for example, a film line coating head. Solvent removal is accomplished, as known in the art, by passing the liquid-adhesive coated release liner through a series of heated zones with controlled air flow at appropriate temperatures. This step in the process results in an even layer of solid, pressure-sensitive adhesive on the coated release liner. Next, the fire extinguishing resin solution is applied, again using for example a film line coating head. Again, solvent removal is accomplished by passing the coated release liner through a series of heated zones with controlled air flow at appropriate temperature and speed. Then, the second pressure-sensitive adhesive layer is coated above the other layers on the release liner, and again solvent is removed by passing the coated release liner through the series of heated zones with a controlled air flow at appropriate temperature and speed. The three-layer construction, with outer layers of adhesive and an inner core loaded with a high concentration of fire retardant on the release liner, is wound in a roll for storage and shipping to the location of its end use. A second release liner may be used to cover the adhesive before rolling if desired.

With this construction, the adhesive film is able to contain more than one and one-half times the amount of fire retardant per unit area than the conventional prior art adhesive films in which the fire retardant pigment is mixed throughout the adhesive. In addition, the adhesive performance is significantly improved in terms of peel adhesion compared to the conventional fire extinguishing adhesive film.

While it will normally be preferred that the adhesive layers remain free of fire retardant pigment, in some applications it may be desirable to load some fire retardant pigment in one or both of the adhesive layers. Further, in broad implementations of certain aspects of the invention, the functional layers need not be pressure sensitive adhesive or even adhesive at all, but may be other functional coatings such as primers, paints, textures, etc.

Other objects and features of the invention may be apparent to those skilled in the art upon reviewing the drawings and the following description thereof.

### BRIEF DESCRIPTION OF THE DRAWINGS

FIG. 1 is a cross-section of an adhesive film with a fire extinguishing core manufactured in accordance with an exemplary embodiment of the invention.

FIG. 2 is a plot showing combustion calorimeter data for an example of film adhesive with a fire extinguishing core manufactured in accordance with the invention compared to a conventional fire retardant film adhesive.

FIGS. 3A, 3B and 3C plot heat release data for specimens of film adhesive with a fire extinguishing core manufactured in accordance with the invention.

### DETAILED DESCRIPTION

One particularly useful application for the invention, as mentioned previously, is in connection with fire retardant adhesive mounting films for decorative wall coatings used in aircraft interiors. The assignee of the present application presently sells a fire retardant thermoplastic film adhesive designed primarily for use in the aerospace industry as a mounting film for decorative laminates. As mentioned, the fire retardant film adhesive is manufactured by blending fire retardant pigments into liquid adhesive and casting the liquid adhesive into a film on release paper which is then converted into finished rolls. In the aerospace industry, the fire retardant adhesive film is normally adhered to a decorative wall coating is made of polyvinylflouride film and the underlying fuselage surface is made of a crushed core panel.

The fire retardant adhesive film is heat activated at 160° C. to 169° C., and at that temperature can be tacked to the back side of the decorative layer. The adhesive backed decorative layer is then vacuum formed to the crushed core panel at the same temperature and at 1.4 Kg/cm-3.52 Kg/cm. The use of the fire retardant thermoplastic film adhesive results in the combination of the decorative coating, adhesive film and crushed core panel being compliant with FAA standards. In this fire retardant adhesive film sold by assignee, fire retardant pigments are mixed homogenously throughout the adhesive at a load of about 16% by weight. Adhesive performance diminishes to an unacceptable level if more fire retardant pigment is added to the adhesive. The manufacture of fire retardant film adhesive involves the application of an adhesive solution (with added fire retardant pigment) to a silicone coated release liner or other substrate followed by a slow cure. The fire retardant pigments are mixed in with the adhesive solution prior to application to the release liner. Typically, the product is provided to the end user in rolls having a width of 2.5 cm-152 cm. The dry film thickness typically ranges between 40 microns to 250 microns, depending primarily on the amount of fire retardant necessary for the given application.

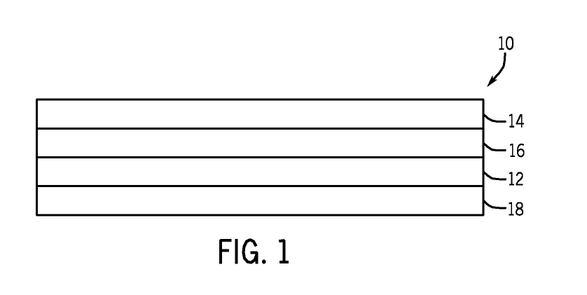

FIG. 1 shows a cross-section for a fire extinguishing, film adhesive 10 manufactured in accordance with the invention. The film adhesive 10 includes a first functional layer 12 of adhesive and a second functional layer 14 of adhesive, as well as a fire retardant core 16. In most applications, the material of the functional layers 12 and 14 will be the same, although aspects of this invention may be implemented with the layers 12 and 14 being made of different adhesive materials. The preferred thickness of the adhesive layers 12, 14 will normally be in the range of 25 to 250 microns; however, the invention is not limited to these thicknesses. The fire extinguishing core 16 can be of any practical thickness depending on the desired fire retardant properties, but in most cases the thickness will be in the range of 25 to 250 microns. In accordance with the invention, the fire retardant core 16 comprises a binding resin loaded with a high concentration of fire retardant pigment, for example at least about 50% by weight fire retardant pigment. Preferably, the fire extinguishing core 16 comprises 10%-50% by weight resin and 50%-90% by weight fire retardants. The functional adhesive layers 12 and 14 preferably contain no fire retardant material; however, the functional adhesive layers 12 and 14 may contain a low level of fire retardant material if desired. The layered fire extinguishing film 10 will normally be manufactured and supplied on a release liner, such as a silicone coated release liner 18.

The fire extinguishing core must be capable of holding a high concentration of fire retardant pigments in order to implement the invention effectively. While the invention can be implemented with the core 16 having a fire retardant pigment concentration as low as about 50% by weight, it is preferred that the resin be capable of holding at least 70% by weight fire retardant pigment. The following resins have been found to be capable of holding at least 70% fire retardant pigments and yet maintain sufficient tensile strength and film properties necessary for processing and structural soundness when in use: polyurethane, polyester, polyacrylate, polyethylene, polypropylene, polyvinylchloride, polyvinylflouride, and polyamide. Other resins capable of being solvated or extruded are legitimate candidates for the core resin as well. It has been found that certain resins are more sensitive to fire retardant loading than other resins. Testing by the inventors has shown that polyurethane resin is able to hold more fire retardant pigment than the other listed resins and yet maintain film integrity and tensile strength. Stress tests conducted on various resins at maximum fire retardant loads indicated that polyurethane is able to withstand more pressure compared to polyamide and copolyester resins. In addition, testing has shown that a cured (heat cured) polyurethane resin matrix is stronger than the uncured polyurethane resin matrix. In the exemplary embodiment of the invention discussed below, the fire extinguishing core 16 comprises a heat-cured polyurethane containing a high concentration of fire retardant pigment mixed throughout along with a small amount of additives such as a cross linking agent and a surfactant.

The particles size for the fire retardant pigment should be relatively small (e.g. less than 75 microns) in order to promote proper blending. The invention may be implemented using various types of fire retardants, but the use of chemical flame retardants is preferred. Chemical flame retardants are substances that can be chemically inserted into a polymer molecule or physically blended in polymers to suppress, reduce, delay or modify the propagation of a flame through a material. There are several classes of chemical flame retardants including halogenated hydrocarbons such as brominated fire retardants, inorganic flame retardants such as antimony oxides and aluminum trihydrates, as well as phosphorus-containing compounds. As described in more detail below in the Example, the preferred fire retardants include a brominated flame retardant, antimony pentoxide and aluminum trihydrate. The brominated fire retardant releases bromine in the free-radical state under the heat of combustion. The bromine free-radicals have a large affinity for hydrogen and oxygen and therefore starve the combustion. The primary purpose of the antimony pentoxide is to cool the reaction and lower heat release.

A wide variety of adhesives can be used to implement the invention as long as the selected adhesive adheres well to the fire extinguishing core 16. In some cases, it may be necessary to use a primer to facilitate proper adhesion. In other cases, such as when a silicone adhesive is used, it may be necessary to use a different resin for the fire extinguishing core, such as a silicone resin instead of a polyurethane resin because the silicone adhesive will not adhere well to polyurethane. The preferred adhesive for the aerospace application is a commercially available pressure sensitive, elastomeric adhesive, Bostik LADH 7583. Other particularly desirable adhesives for implementing the invention include acrylic pressure sensitive adhesives, copolyester, polyurethane, polyamide thermoplastic and thermoset adhesives.

In the exemplary embodiment below, the adhesive layers contain no fire retardant. This is believed to be an advantage in most circumstances because the fire retardant in the underlying fire extinguishing film core needs a thermal reaction to become effective. When fire retardant is present in the adhesive, it retards the combustion of the adhesive layer. When the adhesive layer is pure adhesive, the combustion of the adhesive tends to be quick, which accelerates the reaction of the high concentration of fire retardants in the fire extinguishing core 16 and the speed at which the fire retardants are released and available to retard burning of other components. On the other hand, the invention can be implemented with fire retardant mixed in the adhesive layers if desirable.

One of the advantages of the invention over the prior art is that a film manufactured in accordance with the invention is able to yield more fire retardant per square meter, and yet provide better adhesive performance. For example, if each adhesive layer is 19 microns and contains no fire retardant, and the fire extinguishing core layer is 12.7 microns and contains 80% by weight fire retardant, the yield is 17.6 g/m² of fire retardant of adhesive film, which is about 1.6 times the amount of fire retardant per area as in the prior art. Also, because there is no fire retardant in the adhesive layers, the peel strength of the adhesive is not compromised.

### EXAMPLE

In an exemplary embodiment of the invention, the fire extinguishing adhesive film 10 comprises functional adhesive layers 12 and 14 made of pressure sensitive adhesive, and in particular the above mentioned Bostik LADH 7583 having a dry film thickness of about 19 microns. The adhesive layers 12, 14 contain no fire retardant in this example. A fire extinguishing film core 16 having a dry film thickness of about 12.7 microns resides between the adhesive film layers 12, 14. In this exemplary embodiment, the following ingredients are blended by shear mixing in order to form a homogenized solution for the fire extinguishing core 16:

TABLE 1

| | | Range |
|---|---|---|
| 2-butoxyethanol | 8.10% | 4-20 |
| MEK | 3.67% | 2-10 |
| Toluene | 6.62% | 3-10 |
| Polyurethane solution 35.54% | | |
| MEK | 4.32% | 3-6 |
| Toluene | 24.24% | 20-30 |
| Polyurethane | 6.98% | 6-20 |
| Ethylenebistetrabromophthalimide | 14.45% | 12-20 |
| Aluminum trihydrate | 21.69% | 20-25 |
| Antimony Pentoxide | 8.70% | 7-10 |
| Blocked isocyanate BL 3175 | 1.21% | 1-2 |
| Surfactant | 0.02% | 0.015-.025 |
| | 100.00% | |

The first column in Table 1 lists the amount by weight percent of each ingredient in the exemplary embodiment. The second column lists by weight percent the range of each ingredient contemplated to be useful in implementing this embodiment of the invention. However, the weight percentage ratio of fire retardant pigment (Ethylenebistetrabromophthalimide, Aluminum Trihydrate, Antimony Pentoxide) to binding resin (Polyurethane) should not exceed 7 to 1.

While the layers of the fire extinguishing adhesive film 10 may be made by other techniques such as extrusion, in the exemplary embodiment the laminated fire extinguishing film 10 is made by coating the first layer 12 of adhesive solution on a master roll of silicone coated release liner 18, and then passing the web at 20 feet/min (6.1 m/min) through warm air at a temperature of 168° F. (75.5° C.) and a flow rate of 4,000 cfm (113,267 liters/min) in order to remove the solvents from the adhesive layer 12. The drying conditions can be modified as desired depending on the qualities of the particular adhesive, as is know in the art. Then, the fire extinguishing core solution listed in Table 1 is coated and dried over the adhesive layer 12 on the release liner 18. The top layer of adhesive solution 14 is then coated and dried over the fire extinguishing core layer 16 in order to form the top adhesive layer 14. The dried film is rolled in a roll of, for example, 60 inches (154 cm) wide by 300 yards (274.32 meters) long.

In the exemplary embodiment, the blocked isocyanate is the cross linker for the polyurethane. When the customer laminates the adhesive film with the fire extinguishing core to the decorative coating, it does so using a vacuum process that heats the film to about 160° C. At this temperature, the isocyanate is activated to cross link the polyurethane to create a higher molecular weight urethane structure, which in turn makes the product more rigid.

It has been found that the use of a tackifying resin in the polyurethane solution for the fire extinguishing core is not necessary for film formation. In fact, removal of the tackifying resin increases the ability of the polyurethane resin to hold a higher concentration of fire retardant. Testing by the inventors has found that a fire retardant load of 86% by weight or slightly above is achievable in the polyurethane resin without the tackifying resin, but that a load of only about 70% by weight is achievable if tackifying solution is added to the polyurethane blend.

The preferred surfactant is Dow Corning additive #57, a non-reactive silicone glycol co-polymer surfactant which is known to aid in pigment dispersion. The use of the surfactant is important because it promotes full coating of the fire retardant particles so that the polyurethane resin forms a substantially continuous, coalesced matrix. Forming a coalesced matrix is important for achieving the necessary tensile strength and structural integrity of the fire extinguishing core 16. It has been found that providing fire retardant with a small average particle size is also important to the formation of a strong, continuous polyurethane matrix. A mean particle size of 50 microns has been found to be adequate, although improved structural performance and possibly higher fire retardant loading concentrations in the polyurethane resin may be achievable with yet smaller particle sizes. In any event, the fire extinguishing core resin 16 in Table 1 provides a concentration of 86% by weight fire retardant in the core 16.

The increased fire retardant loading enables the invention to perform very well for the sixty second vertical burn test required by the FAA, FAR 25.853 a. Part 1, Appendix F. In particular, testing has shown that burn length is quite similar to the prior art, but burn time is substantially reduced from slightly under five seconds to slightly under two seconds. Also, no drips are produced, which is similar to the prior art.

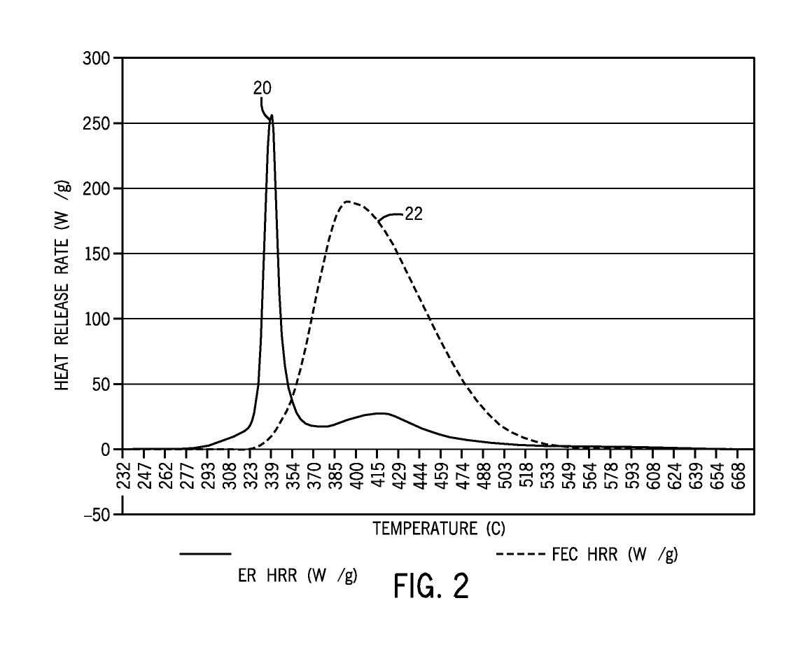

FIG. 2 shows microscale combustion calorimeter data comparing the prior art fire retardant adhesive film (20) to the fire extinguishing core adhesive film (22) manufactured in accordance with the exemplary embodiment 10 of the invention. From FIG. 2, it can be seen that the invention reduces the maximum level of heat release rate from a value of about 260 watts per gram to a value of about 185 watts per gram. In addition, the heat is released at higher temperatures with invention.

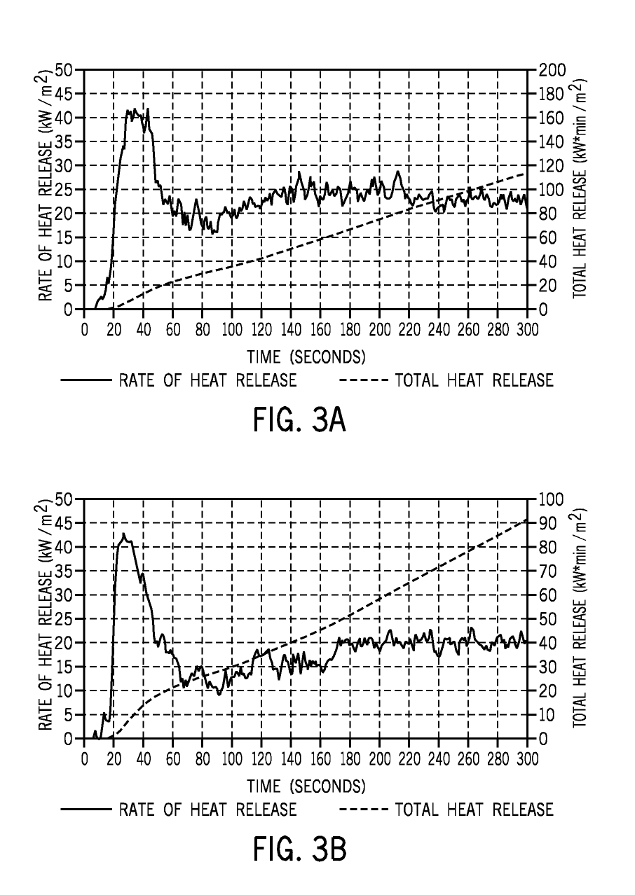

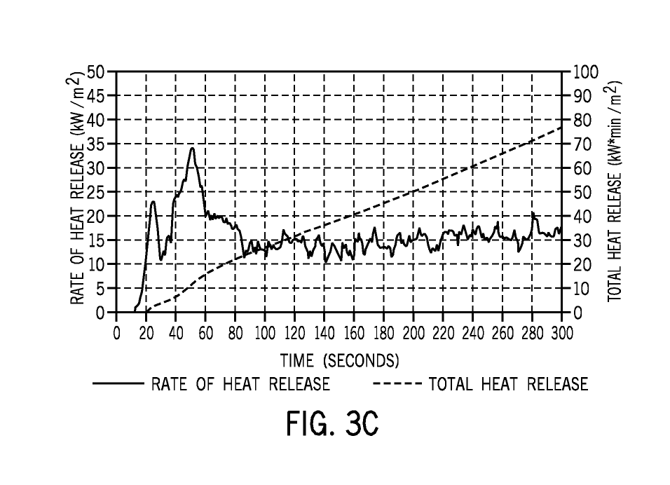

FIGS. 3A, 3B, 3C illustrate Ohio State heat release data for three specimens manufactured in accordance with the exemplary embodiment. In each plot, the rate of heat release and the total heat release for the specimen under the conditions governed by the Ohio State protocol are plotted with respect to time. In all cases, it can be seen that the maximum rate of heat release (x-axis) is substantially under the FAA standard of 60 kW/m². Also, for each specimen, it can be seen that the total heat release at 120 seconds is substantially below the level of 100 kW*min/m² which is the FAA standard.

Those skilled in the art will understand that fire extinguishing polyurethane resin may be useful for numerous other applications. For example, another use of the fire extinguishing resin is as a non-adhesive embossing resin, such as those used to 3-dimensional structural texture of certain wall coatings. Also, it is not necessary that the fire extinguishing polyurethane core be laid down as a layer in a laminated structure. The fire extinguishing polyurethane core can take other structural forms, such as extruded lanes within the adhesive film.

In the foregoing description, certain terms have been used for brevity, clearness, and understanding. No unnecessary limitations are to be inferred therefrom beyond the requirement of the prior art because such terms are used for descriptive purposes and are intended to be broadly construed. The different configurations, systems, and method steps described herein may be used alone or in combination with other configurations, systems and method steps. It is to be expected that various equivalents, alternatives and modifications are possible within the scope of the appended claims.

What is claimed is:

1. A fire extinguishing adhesive film comprising:
a release liner;
a first functional layer comprising adhesive on one side of the release liner;
a fire extinguishing core located on the first functional layer, the fire extinguishing core comprising a blend of resin and a high concentration of fire retardant pigment wherein the resin and the fire retardant pigment forms a coalesced matrix; and
a second functional layer comprising adhesive layered over the fire retardant core.

2. A fire extinguishing adhesive film as recited in claim 1 wherein resin of the fire extinguishing core is capable of being solvated or extruded, and is also capable of holding in its dry form at least about 50% by weight fire retardant pigments within the coalesced matrix.

3. A fire extinguishing adhesive film as recited in claim 1 wherein resin of the fire extinguishing core is capable of being solvated or extruded, and is also capable of holding in its dry form at least 70% by weight fire retardant pigments within the coalesced matrix.

4. A fire extinguishing adhesive film as recited in claim 3 wherein the resin is selected from the group consisting of polyurethane, polyester, polyacrylate, polyethylene, polypropylene, polyvinylchloride, polyvinylflouride, and polyamide.

5. A fire extinguishing adhesive film as recited in claim 1 wherein the resin comprises polyurethane.

6. A fire extinguishing adhesive film as recited in claim 1 wherein the fire extinguishing core is a film layer located between the first and second functional layers of adhesive.

7. A fire extinguishing adhesive film as recited in claim 6 wherein one or more layers of primers are located between the fire extinguishing core layer and the first or second functional layers of adhesive.

8. A fire extinguishing adhesive film as recited in claim 1 wherein the fire extinguishing core comprises in the solid state: 6 to 20 parts polyurethane and 39 to 55 parts fire retardant pigment.

9. A fire extinguishing adhesive film as recited in claim 8 wherein the fire extinguishing core in the dry state further comprises 1 to 2 parts blocked isocyanate.

10. A fire extinguishing adhesive film as recited in claim 1 wherein the fire retardant core is made from a manufacturing solution comprising the following ingredients: solvents, polyurethane solution containing polyurethane and solvents, fire retardant pigments, and an effective amount of surfactant.

11. A fire extinguishing adhesive film as recited in claim 10 wherein the manufacturing solution also comprises blocked isocyanate.

12. A fire extinguishing adhesive film as recited in claim 11 wherein:
the solvents consist of 4 to 20 parts 2-butoxyethanol, 2 to 10 parts methyl ethyl ketone and 3 to 10 parts toluene;
the polyurethane solution consists of 3 to 6 parts methyl ethyl ketone, 20 to 30 parts toluene, and 6 to 20 parts polyurethane;
the fire retardant pigments consist of 12 to 20 parts ethylenebistetrabromophthalimide, 20 to 25 parts aluminum trihydrate, and 7 to 10 parts antimonypentoxide; and
the blocked isocyanate comprises 1 to 2 parts blocked isocyanate.

13. A fire extinguishing adhesive film as recited in claim 12 wherein the ingredients of the manufacturing solution are blended in substantially the following amounts: 8.1% 2-butoxyethanol, 3.67% methyl ethyl ketone, 6.62% toluene, 35.54% polyurethane solution, 14.45% ethylenebistetrabromophthalimide, 21.69% aluminum trihydrate, 8.7% antimony pentoxide and 1.21% blocked isocyanate and an effective amount of surfactant.

14. A fire extinguishing adhesive film as recited in claim 1 wherein the adhesive of the first functional layer and second functional layer are pressure sensitive acrylic adhesives.

15. A fire extinguishing adhesive film as recited in claim 14 further comprising a second release liner over the second functional layer of pressure sensitive adhesive.

16. A blended fire extinguishing resin impregnated with fire retardant pigment comprising 6 to 20 parts polyurethane resin and 39 to 55 parts fire retardant pigment.

17. A blended fire extinguishing resin impregnated with fire retardant pigment as recited in claim 16 further comprising 1 to 2 parts blocked isocyanate.

18. A blended fire extinguishing resin impregnated with fire retardant pigment as recited in claim 16 wherein the fire retardant pigments consists of 12 to 20 parts ethylenebistetrabromophthalimide, 20 to 25 parts aluminum trihydrate and 7 to 10 parts antimony pentoxide.
